(19) United States
(12) Patent Application Publication
(10) Pub. No.: US 2011/0234495 A1
(43) Pub. Date: Sep. 29, 2011

(54) PROGRAMMABLE TOUCH SENSITIVE CONTROLLER

(76) Inventors: Hoe Chan, Singapore (SG); Wui Kwang Tan, Singapore (SG)

(21) Appl. No.: 12/670,826

(22) PCT Filed: Jul. 26, 2007
(86) PCT No.: PCT/US2007/016754

§ 371 Date: Feb. 7, 2011

(51) Int. Cl. G09G 5/08

(52) U.S. Cl. 345/163

(57) ABSTRACT

An improved user input device is disclosed having touch-sensitive areas. The touch-sensitive device may be implemented in a standard computer mouse, replacing the traditional buttons with a touch-sensitive region that may be configured specifically for the user or application desired. Alternatively, the touch-sensitive region may be incorporated into an otherwise traditional QWERTY keyboard. The touch-sensitive area may be programmed or mechanically actuated with a touch-sensitive membrane.

### FIELD OF THE INVENTION

The present invention relates generally to the field of computer peripherals, and more particularly to user input devices such as touch sensitive controllers.

### BACKGROUND OF THE INVENTION

A user input device or controller is a hardware device that sends information to the CPU for processing. Without any form of user input, a computer would lack interactivity, and function simply as a display device, much like a TV. Current input devices come in many configurations, including joysticks, keyboards, mice, game pads, touch pads and microphones.

Most computer programs require a large and frequent variety of human input through a mouse and/or a keyboard. Often, a user is unable to use certain computer programs to the fullest extent (if at all) in the absence of a mouse or a keyboard. Such computer programs comprise anything from word processing programs to massively multi-player online role-playing games (commonly known as “MMORPG”), and to highly specialized graphic design software.

For user input, computer mice have typically had three buttons (the two main mouse buttons and a sliding scroll wheel). On a standard QWERTY keyboard, there are traditionally up to 104/105 keys. Modern keyboards may offer more, including hot keys to launch certain applications.

Currently, certain applications allow each button of a mouse and certain buttons on a keyboard to be assignable to different commands, macros or combination of keyboard strokes. Many computer programs have a plethora of commands that can be used for a given task. For example, in a typical MMORPG, the user can control a character to perform 70-80 actions or more. Naturally, not all are in the same order of importance to the user or are used with the same frequency.

There are inherent design limitations in current human interface devices such as a mouse and/or keyboard. With respect to the mouse, the placements of the buttons and scroll wheel are usually in the same place for every mouse (with only minor variations). Similarly, for a keyboard, the standard layout of QWERTY keyboard buttons and the number pad buttons are usually in the same fixed position (with only minor variations). Additionally, because the placement of the buttons is fixed, the placement of the buttons might not have the same ergonomic factor for all users and may not suit the anatomy of every computer mouse user, e.g., small hands or slightly longer fingers.

Because of the plethora of commands, these commands or combinations of commands must usually be used to maximize the performance, utility and/or enjoyment of the computer program.

Current human interface devices are limited by the placement of the buttons, the number of buttons and the lack of dedicated buttons/keys to multiples of commands in different software (though this last issue is vitiated somewhat by the ability to program and map certain keys on a mouse or keyboard to different functions). If a user of a program has easier, faster or more convenient access to such commands, the productivity, efficient and even enjoyment of using the said computer program will be enhanced.

Touchpads on laptop computers provide an alternative user input format. Touchpads operate by sensing the capacitance of a finger, or the capacitance between sensors. Capacitive sensors are generally laid out along the horizontal and vertical axes of the touchpad. The location of the finger is determined from the pattern of capacitance from these sensors. Some touchpads can emulate multiple mouse buttons by either tapping in a special corner of the pad, or by tapping with two or more fingers. Such touchpads, however, are typically located on a laptop computer itself, and may not be ideally situated for a particular user or application.

Accordingly, it is an object of the present invention to provide a user input device such as computer mouse, keyboard or other device that advantageously incorporates aspects of a touch pad and can be optimized for particular applications and to specific users' preferences.

### SUMMARY OF THE INVENTION

An improved user input device is disclosed having touch-sensitive regions and having ergonomically-configurable features to custom fit individual users.

In accordance of the present invention, a human interface device can be configured to change the number, placement and functions of buttons on a mouse or keyboard through the placement of touch-sensitive surfaces (but not necessarily restricted to capacitive, resistive or infra-red technology) on any portion of a mouse, keyboard or other human interface device.

This touch-sensitive surface can be programmed or customized by the user so that the user can specify which area of the touch sensitive surface when activated will launch a command, a series of commands, macros or combination of keystrokes. In so doing, there can be a very large number and combination of segments of the touch-sensitive surface which when activated will launch different commands.

Such programming or customizing may be accomplished by the user through a graphic user-interface (GUI) so that the user can assign pre-determined segments of the touch-sensitive surface to launch certain commands when activated. The user may also opt to select various sections of the touch-sensitive surface in a free form manner to his discretion. The GUI may contain a visual representation of the touch-sensitive surface to be mapped at the user's discretion.

In a preferred embodiment, the user may also map certain portions of the touch-sensitive surface so that it activates no commands when activated. In this way, the user may opt to only map the segments of the touch-sensitive surface which are within easy reach of his fingers (at his discretion) or are more ergonomically comfortable to activate.

### BRIEF DESCRIPTION OF THE DRAWINGS

The foregoing and other advantages of the invention will become apparent upon reading the following detailed description and upon reference to the drawings, wherein:

FIG. 1 is a simplified top-down schematic view of a touch-sensitive region disposed on the top surface of a computer mouse in accordance with the present invention.

FIG. 2 illustrates a simplified top-down schematic view of a touch-sensitive region disposed on the top surface of a computer mouse having four independent regions in accordance with the present invention.

FIG. 3 illustrates a simplified top-down schematic view of an alternative touch-sensitive region disposed on the top surface of a computer mouse in accordance with another aspect of the present invention.

FIG. 4 illustrates a simplified top-down schematic view of a touch-sensitive region disposed on the top surface of a computer mouse having four independent color-coded regions in accordance with the present invention.

FIG. 5 illustrates a simplified top-down view of a touch-sensitive region on a mouse as in FIG. 2, further comprising visual and/or tactile demarcation boundaries.

FIG. 6 illustrates a simplified top-down view of a touch-sensitive region on a mouse as in FIG. 2, further comprising texturing to identify independent regions.

FIG. 7 illustrates a simplified top-down view of a touch-sensitive region on a mouse as in FIG. 2, further comprising visual labels associated with specific actions.

FIG. 8 illustrates a simplified top-down view of a touch-sensitive region on a mouse as in FIG. 2, further comprising visual labels for function keys.

FIG. 9 illustrates a simplified top-down view of a QWERTY keyboard modified in accordance with one aspect of the present invention.

FIG. 10 illustrates a simplified top-down view of a QWERTY keyboard modified in accordance with another aspect of the present invention.

FIG. 11 illustrates a simplified top-down view of a QWERTY keyboard modified in accordance with yet another aspect of the present invention.

FIG. 12 illustrates a simplified top-down view of a touch-pad device in accordance with the present invention.

FIG. 13 illustrates a simplified cross-sectional view of a touch-sensitive surface in accordance with an embodiment of the present invention.

FIG. 14 illustrates a simplified cross-sectional view of a touch-sensitive surface in accordance with another embodiment of the present invention.

While the invention is susceptible to, various modifications and alternative forms, specific embodiment's have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF PREFERRED EMBODIMENTS

As summarized above, embodiments of the invention provide a programmable touch-sensitive region on a user input device, with optional mechanical actuation.

In accordance with one aspect of the present invention, programming or customizing may be accomplished by the user through a graphic user-interface (GUI) so that the user can assign pre-determined segments of the touch-sensitive surface to launch certain commands when activated. The user may also opt to select various sections of the touch-sensitive surface in a free form manner to his discretion. The GUI may contain a visual representation of the touch-sensitive surface to be mapped at the user's discretion.

The user may also map certain portions of the touch-sensitive surface so that it activates no commands when activated. In this way, the user may opt to only map the segments of the touch-sensitive surface which are within easy reach of her fingers (at her discretion) or are more ergonomically comfortable to activate.

The activation of the area may be through a touch of the specific area of the touch-sensitive surface, a combination of touches to a specific area of a the touch-sensitive surface, the mechanical actuation of that portion of the touch-sensitive surface, a combination of mechanical actuations of portions of the touch-sensitive surface or a variety of combinations of touches and mechanical actuations on the touch-sensitive surface.

The touch-sensitive surface may also be able to detect multiple touches at the same time, the intensity of the touch (strength used), and the speed of a touch (in the event of a swipe of the touch-sensitive surface), upon which different series of commands may be launched.

In order for the user to demarcate and identify the different map-able segments of the touch-sensitive surface customized by the user, the areas may be demarcated by use of one or more of the following:
a) lights;
b) colors;
c) visual lines and characters;
d) texture or physical bumps on the surface;
e) small screens below it which shows different icons or pictures;
f) by pictures on the segments themselves;
g) an overlay for standardized mapping;
h) a charged layer which creates text, pictures or colors which does not require electricity to power;
i) generating a customizable tactile surface with the addition of replaceable, transparent overlays that allow a user to rest fingers on surface without actuation; or
j) generating a customizable tactile surface through the use of the electrically stimulated programmable surface that will allow the creation of any shape to conform to the display below.

The foregoing may be used individually or in combination with one another.

Any lights, colors or visuals lines are able to be programmed to blink or pulsate in a certain manner for cosmetic effect, regardless of whether it is programmed to perform certain functions.

Turning now to the figures, traditionally, a mouse has two buttons, A and B (not shown). As shown in FIG. 1, the region in which those buttons are usually located (1 and 2), can, in accordance with the present invention, be replaced with a touch-sensitive surface instead of traditional buttons which must be mechanically actuated.

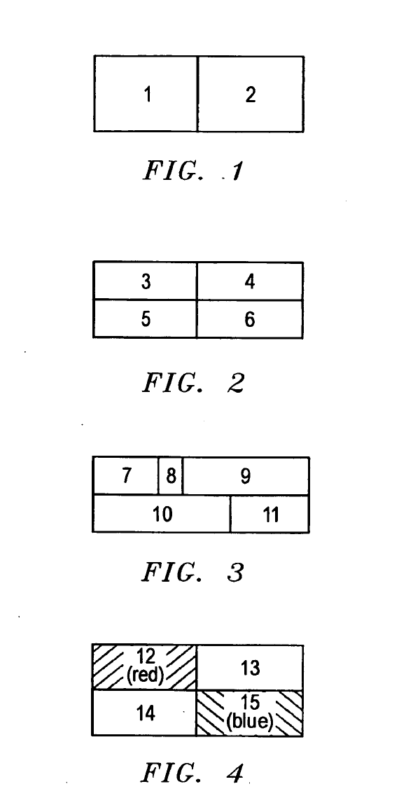

If the surface of buttons A and B is replaced with a touch-sensitive surface, it can be mapped in accordance with an aspect of the invention to provide four or more buttons, as shown generally in FIG. 2. In FIG. 2, button A has been replaced with two discrete touch-sensitive surfaces (3, 5), whereas button B has been replaced with two additional touch-sensitive surfaces (4, 6).

Alternatively, as depicted in FIG. 3, the touch sensitive surface may be segmented in a free-form manner to suit the user's ergonomics. In this example, five touch-sensitive segments (7-11) are shown. As the touch-sensitive surface is also able to detect multiple touches, the strength of the touch and the speed of a swipe, in one embodiment, area 8 is mapped to function like a scroll wheel, both forwards and backwards and sideways.

When segmenting touch-sensitive areas, it is often useful to demarcate independent areas so that the user is given a clear indication of what inputs will be provided to the central processing unit. This may be accomplished in several ways. For example, as shown in FIG. 4, to demarcate different areas, some areas may be configured to emit light of different colors. In the example shown, area 12 emits red light or a red glow, and area 15 gives off a blue light or a blue glow so they can be easily demarcated and identified by the user.

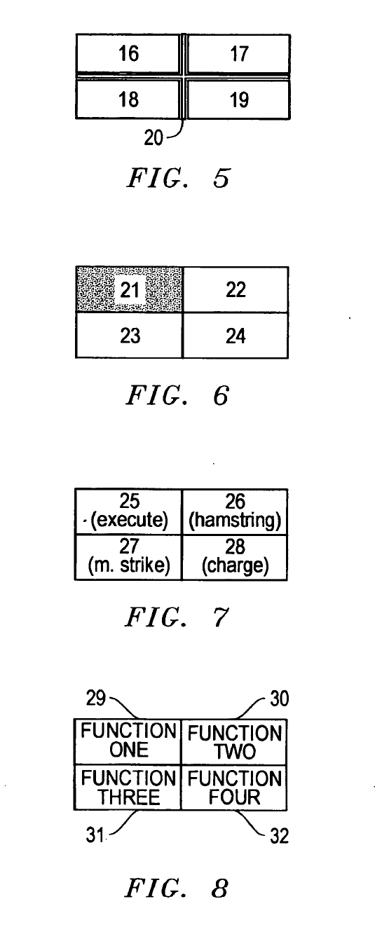

In an alternative embodiment, the touch sensitive surface is segmented through a pre-determined grid layout may contain pre-imprinted lines 20 on the touch-sensitive surface as well, segregating the touch-sensitive areas 16-19. This embodiment is depicted in FIG. 5. Lines 20 may be visual (e.g., forming a grid) or may physically demarcate regions with raised ridges or recessed channels.

In yet another alternative embodiment, the various segments of the touch-sensitive surfaces are demarcated by texture. As shown in FIG. 6, differing textures may be applied to some (e.g., 21) or all (21-24) of the segments.

In another embodiment shown in FIG. 7, the various segments of the touch-sensitive surfaces (25-28) are labeled by a small screen next to it.

As shown in FIG. 8, the various segments of the touch-sensitive surfaces (29-32) may be converted to a screen and display a picture, text or an icon on it to show the function mapped to it. The touch-sensitive surfaces may alternately be placed on the left and right sides of the mouse or anywhere on the mouse to provide an infinite variety of buttons and button layouts.

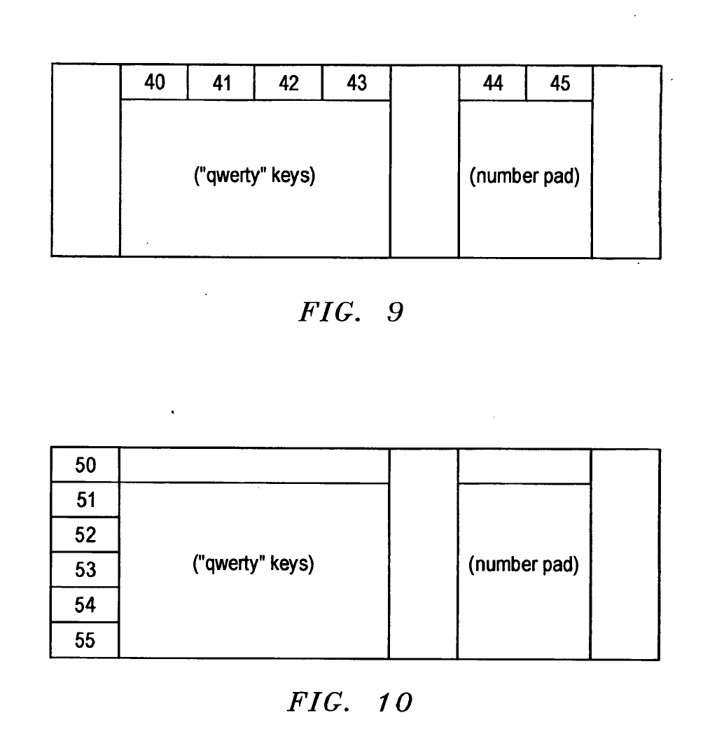

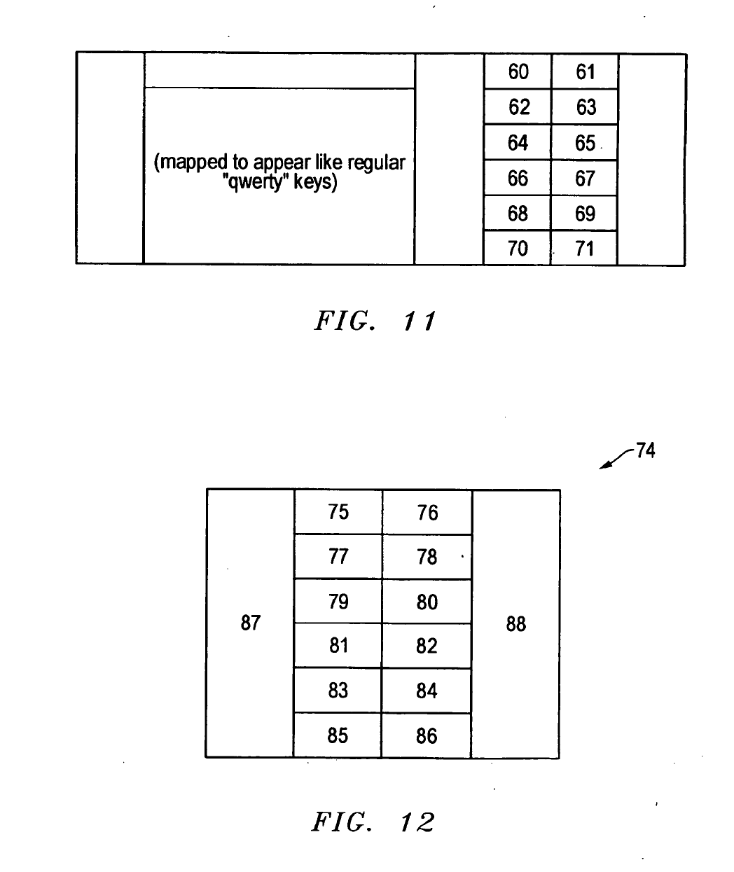

Instead of a handheld device like a touchpad, a keyboard can be adapted with touch-sensitive surface on it above, beside or below the usual “QWERTY” keys and this surface can also be mapped. In the example shown in FIG. 9, the touch-sensitive surface is on the top part of the key board and has been mapped to six segments, 40-45, the activation of each of which launches a different function. The different functions may be programmable or pre-established. If programmable, the keyboard can be additionally provided with a nonvolatile memory (not shown), or the application can perform the mapping through software. FIG. 10 shows the touch-sensitive surface disposed at the side of the “QWERTY” keys and has been mapped to six segments 50-55, the activation of each would launch a different function.

In FIG. 11, the entire keyboard is a touch-sensitive surface. The user can opt to program the keyboard to act as regular keyboard, with each segment mapped to where the keys in a normal keyboard would appear. Optionally, instead of a number pad, that section of the touch-sensitive is customized to suit the user's needs. In this example, the traditional number pad region has been replaced with twelve regions 60-71. The “QWERTY” keys section may also contain an overlay to show where the keys are mapped as it is a standard layout.

In a preferred embodiment, the regions themselves are programmable. An application can thus establish specific regions for the device that are specially tailored for that application and control inputs required thereby. Alternatively, using a graphical user interface, a user may“design” a specific layout directed to a particular application, user preference, or both, and that design may be stored for later use. Multiple such profiles may be stored for later recall.

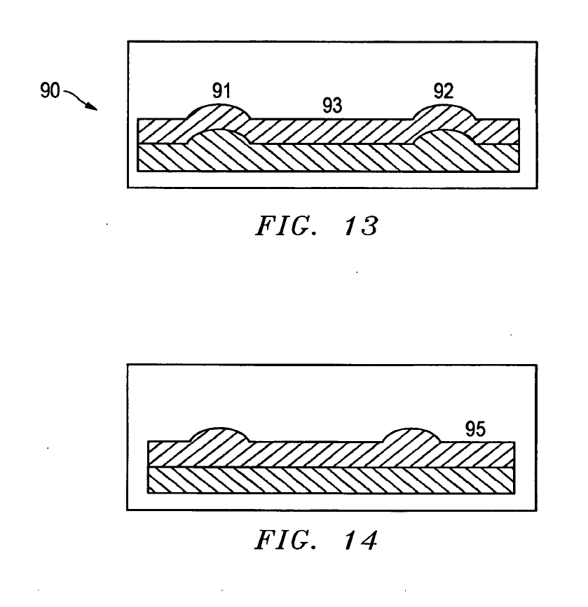

As shown in FIG. 12, instead of an entire keyboard, a gamepad can implement the touch solution described herein. Touchpad 74 consists of a touch-sensitive surface and the user can select different segments 75-88 to launch different commands.

In an alternative embodiment, in FIG. 13, the entire human interface device consists of a touch-sensitive surface and the demarcation is through the use of an electronically stimulated membrane 90. The membrane creates bumps (91, 92) or textures on the surface 93. Alternatively, it creates an ergonomic shape to suit a user's hands. An electrically stimulated programmable surface can be used that allows the creation of any shape to conform to the display below.

In one embodiment, the electrically stimulated programmable surface uses a material such as electrorheological fluid. Electrorheological fluids (ER fluids) are suspensions of extremely fine electrically active particles (generally up to 50 micrometres in diameter) in a non-conducting fluid. The apparent viscosity of these fluids changes reversibly by an order of 10⁵ in response to an electric field. For example, a typical ER fluid can go from the consistency of a liquid to that of a gel, and back, with response times on the order of milliseconds. ER fluids of this type are generally described in U.S. Patent Publication No. 2006/0099808, which is incorporated herein by reference in its entirety as if fully set forth herein.

FIG. 14 shows a customizable tactile surface through the addition of replaceable, transparent overlays 95 on to the touch-sensitive surface. The added advantage of this embodiment is that users can rest their fingers on the overlays 95 as they normally would the keys on a keyboard without actuating the keys.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A touch-sensitive computer input device comprising:
a housing adapted to be held within a hand of a user, said housing having an interior region and top and bottom surfaces, said top surface having front and back areas;
a mouse subsystem within said housing and adapted to measure movement of the input device along an x-axis and a y-axis;
a touch sensitive surface on said front area, wherein said touch sensitive surface comprises a plurality of demarcated regions corresponding to a plurality of input signals, said demarcated regions adapted to be controlled by at least an index finger and a middle finger of said hand of said user while said housing is held within said user's hand.

2. The input device of claim 1, wherein said demarcated regions are color-coded.

3. The input device of claim 1, wherein said demarcated regions are identifiable by texture.

4. The input device of claim 1, wherein said demarcated regions are identifiable by illumination.

5. The input device of claim 1, wherein said demarcated regions are identifiable by a charged layer which creates a visual display, and wherein said charged layer does not require electricity to power.

6. The input device of claim 1, wherein said touch sensitive surface comprises an electronically stimulated membrane.

7. The input device of claim 6, wherein said electronically stimulated membrane comprises electrorheological fluid.

8. The input device of claim 6, wherein said electronically stimulated membrane is programmable.

9. The input device of claim 1, further comprising a memory.

10. The input device of claim 9, wherein said memory is programmed with one or more profiles associated with one or more desired layouts for said demarcated regions.

11. The input device of claim 1, wherein said device is generally shaped like a traditional computer mouse.

12. The input device of claim 11, comprising four demarcated regions.

13. The input device of claim 11, comprising six demarcated regions.

14. The input device of claim 1, wherein said demarcated regions can be programmed to blink or pulsate for visual effect, regardless of whether said demarcated regions are programmed to perform one or more functions.

15. The input device of claim 1, wherein at least one of said demarcated regions is adapted to function like a scroll wheel.

16. The input device of claim 15, wherein said at least one of said demarcated regions is adapted to detect a strength of touch.

17. The input device of claim 15, wherein said at least one of said demarcated regions is adapted to detect a speed of swipe.

18. The input device of claim 1, further comprising a second touch sensitive surface not disposed on said front area but disposed elsewhere on said housing.

19. The input device of claim 1, further comprising software responsive to a graphical user interface for creating a plurality of associations between said demarcated regions and a plurality of control inputs.

20. The input device of claim 1, further comprising replaceable, transparent overlays adapted to rest above said demarcated regions.

21. A touch-sensitive computer input device comprising:
a keyboard comprising a plurality of keys;
adjoining said keyboard, a plurality of demarcated, touch sensitive regions.

22. The input device of claim 21, further comprising a nonvolatile memory for storing a plurality of associations between said demarcated regions and a plurality of control inputs.

23. The input device of claim 21, further comprising software responsive to a graphical user interface for creating said associations.

24. The input device of claim 21, wherein said demarcated regions are color-coded.

25. The input device of claim 21, wherein said demarcated regions are identifiable by texture.

26. The input device of claim 21, wherein said demarcated regions are identifiable by illumination.

27. The input device of claim 21, wherein said touch sensitive regions comprise an electronically stimulated membrane.

28. The input device of claim 27, wherein said electronically stimulated membrane is programmable.

29. The input device of claim 27, wherein said electronically stimulated membrane comprises electrorheological fluid.

30. The input device of claim 21, wherein said keyboard comprises a full QWERTY keyboard.

31. The input device of claim 21, wherein said demarcated regions can be programmed to blink or pulsate for visual effect, regardless of whether said demarcated regions are programmed to perform one or more functions.

32. The input device of claim 21, wherein at least one of said demarcated regions is adapted to function like a scroll wheel.

33. The input device of claim 32, wherein said at least one of said demarcated regions is adapted to detect a strength of touch.

34. The input device of claim 32, wherein said at least one of said demarcated regions is adapted to detect a speed of swipe.

35. The input device of claim 21, further comprising replaceable, transparent overlays adapted to rest above said demarcated regions.

36. A touch-sensitive computer input device comprising:
an exterior housing;
disposed on said exterior housing, a plurality of demarcated, touch sensitive regions, said touch sensitive regions having a plurality of associations between with a plurality of control inputs;
wherein said plurality of associations are programmable using a graphical user interface.

37. The input device of claim 36, further comprising software adapted for creating a plurality of profiles, each of said profiles having a different plurality of associations.

38. The input device of claim 37, further comprising a nonvolatile memory for storing said plurality of profiles.

39. The input device of claim 38, wherein said nonvolatile memory is located within said input device.

40. The input device of claim 38, further comprising a second memory for storing an active profile selected from said plurality of profiles.

41. The input device of claim 36, wherein said demarcated regions are color-coded.

42. The input device of claim 36, wherein said demarcated regions are identifiable by texture.

43. The input device of claim 36, wherein said demarcated regions are identifiable by illumination.

44. The input device of claim 36, wherein said touch sensitive regions comprise an electronically stimulated membrane.

45. The input device of claim 44, wherein said electronically stimulated membrane is programmable.

46. The input device of claim 44, wherein said electronically stimulated membrane comprises electrorheological fluid.

47. The input device of claim 36, wherein said demarcated regions can be programmed to blink or pulsate for visual effect, regardless of whether said demarcated regions are programmed to perform one or more functions.

48. The input device of claim 36, wherein at least one of said demarcated regions is adapted to function like a scroll wheel.

49. The input device of claim 48, wherein said at least one of said demarcated regions is adapted to detect a strength of touch.

50. The input device of claim 48, wherein said at least one of said demarcated regions is adapted to detect a speed of swipe.

51. The input device of claim 36, further comprising replaceable, transparent overlays adapted to rest above said demarcated regions.

52. The input device of claim 36, wherein said device is a gamepad.

53. The input device of claim 36, wherein said device is a computer mouse.

54. The input device of claim 36, wherein said device is a computer keyboard.
